(19) United States
(12) Patent Application Publication
(10) Pub. No.: US 2009/0072653 A1
(43) Pub. Date: Mar. 19, 2009

(54) Stator Structure of Rotary Electric Machine and Method of Manufacturing the Same

(75) Inventors: Kenji Harada, Nishikamo-gun (JP); Shingo Fubuki, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/226,529

(22) PCT Filed: Oct. 3, 2007
(86) PCT No.: PCT/JP2007/069791

§ 371 Date: Oct. 21, 2008

(30) Foreign Application Priority Data
Oct. 27, 2006 (JP) 2006-292943

(51) Int. Cl. H02K 3/28; H02K 15/04

(52) U.S. Cl. 310/208; 29/596

(57) ABSTRACT

A stator of rotary electric machine includes a plurality of winding bodies of a concentrated winding type in which two conductive wires are wound in rows. Assuming that the number of conductive wires supplied to each winding body is P, the number of slots (winding bodies) of the entire stator is T, and the number of neutral points (the number of stars) is S, winding wires extending between the winding bodies are twisted at spacing intervals of N winding bodies (N is a natural number) determined to satisfy the following relation: T=3×S×P×N.

### TECHNICAL FIELD

The present invention relates to a rotary electric machine used in an electric vehicle or the like and, more particularly, to a stator structure included in a rotary electric machine, and a method of manufacturing the stator structure.

### BACKGROUND ART

This type of stator structure is, for example, a concentrated winding coil as disclosed in Jpn. unexamined patent publication No. 2000-197294. The concentrated winding coil has a coil wire (a conductive wire) having a rectangular cross section wound to form a plurality of layers, so that the conductive wire is wound in rows in each layer. In this coil, a row change part where the conductive wire shifts from one row to another, and a layer change part where the conductive wire shifts from one layer to an adjacent one have a circular cross section.

### DISCLOSURE OF INVENTION

### Problems to be Solved by the Invention

In the concentrated winding coil as disclosed in Jpn. unexamined patent publication No. 2000-197294, a plurality of conductive wires is wound around one slot in each phase. When the plurality of conductive wires such as parallel wires are wound in rows, there may occur unbalance of leakage magnetic flux induced in each conductive wire in the slot, or a difference in inductance due to a difference in circumferential length of individual conductive wires in the same turn depending on how to wind. This may result in loss of circulating electric current or the like, thus leading to a problem of insulating properties. In order to cope with this problem, it is proposed that two wires are twisted several times during winding of one coil to interchange the positions of the windings on a coil end. However, this twisting of the windings may cause problems of break in winding, of a bulky coil end, and the like.

The invention has been made in view of the forgoing problems and has an object to provide a stator structure of a rotary electric machine which can prevent winding wires from becoming disordered or bulky and further can reduce the loss of circulating electric current or the like.

### Means for Solving the Problems

The above objects are attained by combinations of the features set forth in independent claim(s), and dependent claims give further advantageous embodiments of the present invention.

Specifically, a first aspect of the present invention provides a stator structure of rotary electric machine, including a plurality of winding bodies of a concentrated winding type, each having a plurality of conductive wires wound in rows, wherein when it is assumed that the number of conductive wires supplied to each of the winding bodies is P, the number of slots (winding bodies) of the entire stator is T, and the number of neutral points (the number of stars) is S, winding wires extending between the winding bodies are twisted at spacing intervals of N winding bodies (N is a natural number) determined to satisfy a relation:

T=3×S×P×N.

With the above-mentioned structure of the invention, in the winding body of a concentrated winding type in which the plurality of conductive wires are wound in rows, the conductive wires are wound around one slot in each phase. However, there may occur influence by unbalance of leakage magnetic flux induced in each conductive wire in the slot, or a difference in inductance due to a difference in circumferential length of individual conductive wires in the same turn. This may result in loss of circulating electric current or the like. According to the above-mentioned structure of the invention, the winding wires extending between the winding bodies are twisted at spacing intervals of N winding bodies for satisfying a predetermined condition. Thus, the difference in inductance due to the difference in leakage magnetic flux between the conductive wires, which may be caused in one winding body, is offset between the winding bodies before and after the twist position in the same phase. The term “twisting” of the winding wires as used herein means that, for example, two conductive wires are rotated by 180°, while kept in parallel, thereby interchanging the positions of these two wires.

Thus, this stator of the rotary electric machine can decrease the loss of the circulating current and the like. In addition, the stator can reduce the winding disorder of the winding wires and make the winding compact.

Preferably, the plurality of conductive wires are two wires of a first conductive wire and a second conductive wire, which are wound in rows as parallel winding wires so that the first conductive wire is wound on an inner side and the second conductive wire is wound on an outer side to overlap the first conductive wire, the first and second conductive wires being wound with the same turns on the inner and outer sides.

In the above structure of the invention, the two conductive wires are wound as the parallel winding wires with the same turns on the inner and outer sides. Therefore, these wires are brought into contact together in combination of the same turns. Thus, a voltage needed between the turns is about a withstand voltage per turn, specifically, a film withstand voltage which is equal to or less than half that in the prior art. Further, the two conductive wires are wound as the parallel winding wires, which can reduce a load applied when the conductive wires are wound.

Accordingly, a difference in potential between turns can be reduced.

Preferably, the winding wires between the winding bodies are coupled to each other through a bus bar with a twisted portion.

According to the above structure of the invention, the winding wires between the winding bodies are coupled to each other through the bus bar with the twist portion. Thus, the winding wires extending between the winding bodies do not need to be twisted, and hence equipment for twisting is not required. The term “bus bar with the twist portion” as used herein means that for example, in use for two conductive wires, the positions of two connection terminals therefor are interchanged between one end and the other end of the bus bar.

Accordingly, a winding machine for winging the conductive wires around the plurality of bobbins can be simplified in structure.

Preferably, the conductive wire has a circular cross section, and the conductive wire wound on the outer side is disposed between the rows of the conductive wire wound on the inner side.

According to the above configuration, a generally used wire having a circular cross section can be used as the conductive wire.

Accordingly, the stator can be manufactured at relatively low cost.

Preferably, the two conductive wires are coated with insulating films made of the same materials.

According to the above configuration, the two conductive wires are coated with the insulating films made of the same material, so that the two conductive wires are bonded to each other with the insulating films.

Accordingly, the winding wires can be prevented from becoming disordered.

Preferably, the plurality of conductive wires are two wires of a first conductive wire and a second conductive wire, which are wound in rows as parallel winding wires so that the parallel winding wires are wound sequentially from an inner side and the parallel winding wires on an outer side are wound to overlap the parallel winding wires wound on the inner side.

According to the above configuration, the wound wires can be united in individual layers.

Accordingly, the winding wires can be prevented from becoming disordered.

According to another aspect, the invention provides a winding machine for any one of the aforementioned stator structures of rotary electric machine, wherein the winding machine includes a conductive wire supply device for individually supplying the conductive wires in such a manner as to supply the conductive wire to be put on the outer side before the conductive wire to be put on the inner side is completely wound by one turn.

According to the above structure of the invention, when the outer side conductive wire is wound on the inner side conductive wire, not only the tension of the outer side conductive wire, but also that of the inner side conductive wire can be adjusted. The inner side conductive wire and the outer side conductive wire are not wound individually, which can lessen the necessary number of winding.

This can reduce damage to the conductive wires due to the winding operation, resulting in a reduction in time required for winding the wires.

Furthermore, according to another aspect, the invention provides a method of manufacturing the aforementioned stator structure of rotary electric machine, wherein the method uses a holding device that holds a plurality of bobbins constituting the winding bodies for the same phase, on the same rotational axis, and the method comprises a series of processes including: winding the conductive wires around one bobbin held at an end position of the holding device; drawing the conductive wires by a crossover length for formation of the stator after the winding of the winding wires around the bobbin; and moving the bobbin along the rotational axis to a predetermined position after the drawing of the conductive wires by the crossover length, and holding another bobbin in the end position of the holding device, the series of processes is repeated to wind the conductive wires around the plurality of bobbins constituting the winding bodies for the same phase.

According to the above structure of the invention, one bobbin is held and the conductive wires are wound around the bobbin. After winding the conductive wires, each of the conductive wires is drawn by a crossover length. The bobbin with the conductive wires wound therearound is moved to a predetermined position, and then another bobbin is held so as to have the conductive wires wound therearound. Such a series of processes are continuously repeated. Thus, a plurality of winding bodies constituting at least one phase are continuously formed, and thus the winding wires do not need to be connected individually every between the winding bodies.

In this way, since the winding wires are not connected individually every between the winding bodies, the manufacturing process of the stator can be simplified.

According to another aspect, the invention provides a method of manufacturing a stator, including: forming a bobbin from a stator core divided into pieces; and arranging a plurality of sets of the winding bodies for different phases manufactured according to the aforementioned method so that the winding bodies of different phases are disposed adjacently and displaced by one phase from one another, and positioning the winding bodies to form an integral annular configuration.

According to the above structure of the invention, the bobbin is constructed of the divided stator core, and the use of the bobbins continuously forms a plurality of winding bodies constituting at least one phase. Further, the respective continuous winding bodies of the adjacent phases are arranged to overlap each other so that the winding bodies of one phase are shifted by one phase from those of the adjacent phase. Finally, these winding bodies are then positioned in an annular shape to be integrally formed as the stator. Thus, each winding body does not need to be individually fixed to the core body, and the windings are not required to be connected individually between the winding bodies.

Since each winding body is not fixed to the core body and the windings are not connected between the winding bodies, accordingly, manufacturing of the stator can be simplified.

### BRIEF DESCRIPTION OF DRAWINGS

FIG. 1 is a front view of a schematic configuration of a stator of a rotary electric machine and enlarged views of parts thereof;

FIG. 2 is a front view of a winding body;

FIG. 3 is an electric circuit diagram showing an electric configuration of the stator;

FIG. 4 is a front view of a series of six winging bodies;

FIG. 5 is a listing showing combinations of numeric values of parameters in an expression (1);

FIG. 6 is a listing showing combinations of numeric values of parameters in the expression (1);

FIG. 7 is a flowchart showing a manufacturing process;

FIG. 8 is an explanatory view showing a step of the process;

FIG. 9 is an explanatory view showing a step of the process;

FIG. 10 is an explanatory view showing a step of the process;

FIG. 11 is an explanatory view showing a step of the process;

FIG. 12 is an explanatory view showing a step of the process;

FIG. 13 is an explanatory view showing a step of the process;

FIG. 14 is a front view of a winding body;

FIG. 15 is a front view of a winding body;

FIG. 16 is a front view of a winding body;

FIG. 17 is a front view of a winding body;

FIG. 18 is a front view of a schematic configuration of a stator of a rotary electric machine and enlarged views of parts thereof.

### BEST MODE FOR CARRYING OUT THE INVENTION

### First Embodiment

A first embodiment of the invention which embodies a stator structure of a rotary electric machine and a manufacturing method thereof will be described below in detail with reference to the accompanying drawings.

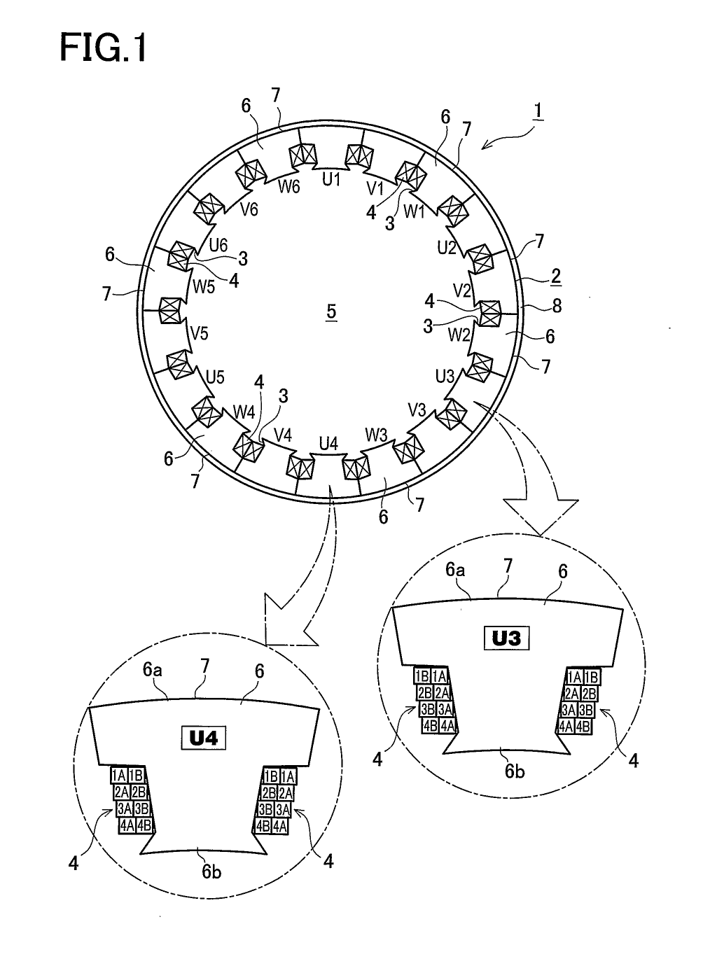

FIG. 1 is a front view showing a schematic configuration of a stator 1 of the rotary electric machine and enlarged views of parts thereof. The stator 1 is of a concentrated winding type made in a single star configuration (one neutral point) with three phases U, V, and W, twelve poles, and eighteen coils. The stator 1 includes an annular stator core 2. Windings 4 are provided in slots 3 of the core 2. A rotator (not shown) is assembled to an inside space 5 of the stator 1 to manufacture the rotary electric machine.

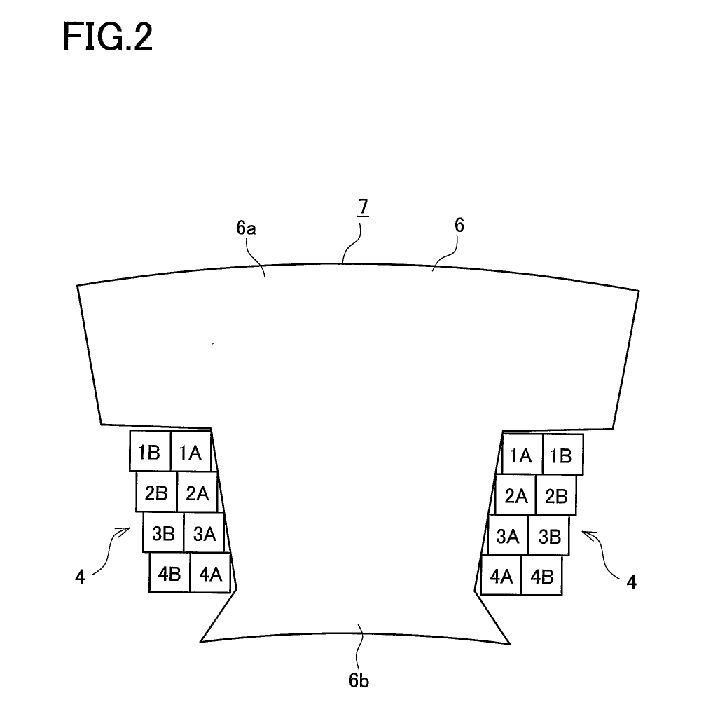

In this embodiment, the stator core 2 is composed of 18 division cores 6 in total previously formed separately. FIG. 2 is a front view showing one winding body 7 made up of one division core 6. In FIG. 2, a section for explaining a wound state of the winding 4 is shown for convenience. Each division core 6 includes a yoke portion 6a constituting the outer periphery of the stator core 2, and a teeth portion 6b protruding toward the center of the core 2, and constitutes a bobbin of the invention. Two conductive wires A and B are wound in rows to provide the winding 4 in the slot 3 (around the teeth portion 6b) of each division core 6 (the conductive wires A and B being described as “1A to 4A”, and “1B to 4B”, respectively, in FIG. 2). In this embodiment, each of the conductive wires A and B has a rectangular shape. In this way, one division core 6 and the winding 4 provided around the division core 6 constitute one winding body 7. In this embodiment, as shown in FIG. 1, the stator 1 includes six winding bodies 7 per phase; concretely, six winding bodies 7 (U1 to U6) for constituting the U phase, six winding bodies 7 (V1 to V6) for constituting the V phase, and six winding bodies 7 (W1 to W6) for constituting the W phase. The division cores 6 respectively have the same shape that can form a part of the annular stator core 2 as shown in FIG. 1. Each division core 6 has a surface insulated. The stator core 2 formed in an annular shape is clamped by a fixing ring 8 attached to the outer periphery of the stator core 2 for integrally fixing all division cores 6, that is, all winding bodies 7.

In this embodiment, the winding body 7 shown in FIG. 2 has the winding 4 formed by turning two conductive wires A and B four times. That is, the winding body 7 includes the first conductive wire A and the second conductive wire B wounded in rows as parallel winding wires. In the winding body 7 shown in FIG. 2, specifically, the first conductive wire A is wound on the inner side, and the second conductive wire B is wound on the outer side to be put on the wire A so that the inner side wire and the outer side wire are wound as the parallel winding wires with the same turn. In other words, referring to FIG. 2 in which reference numerals “1 to 4” given to the winding wires A and B for convenience designate the numbers of respective turns (and the same goes for other drawings), at the first turn, the first conductive wire 1A is wound on the inner side, and the second conductive wire 1B is wound on the outer side. At the second turn, the first conductive wire 2A is wound on the inner side, and the second conductive wire 2B is wound on the outer side. Similarly, the conductive wires 3A and 3B at the third turn, and the conductive wires 4A and 4B at the fourth turn are wound in succession.

Referring now to FIG. 1, the winding bodies 7 of the respective U, V, W phases are arranged in succession such that the different phases are adjacent to each other. That is, the winding bodies 7 of the “U1, V1, W1” phases are arranged in parallel in this order. Subsequently, the winding bodies 7 of the “U2, V2, W2” phases are arranged in parallel in this order. The remaining winding bodies are arranged in succession in the same way as described above. The six winding bodies 7 constituting the same phase, for example, the adjacent winding bodies 7 of the U1 to U6, are respectively connected to each other by two conductive wires A and B, which are portions continued from each winding 4.

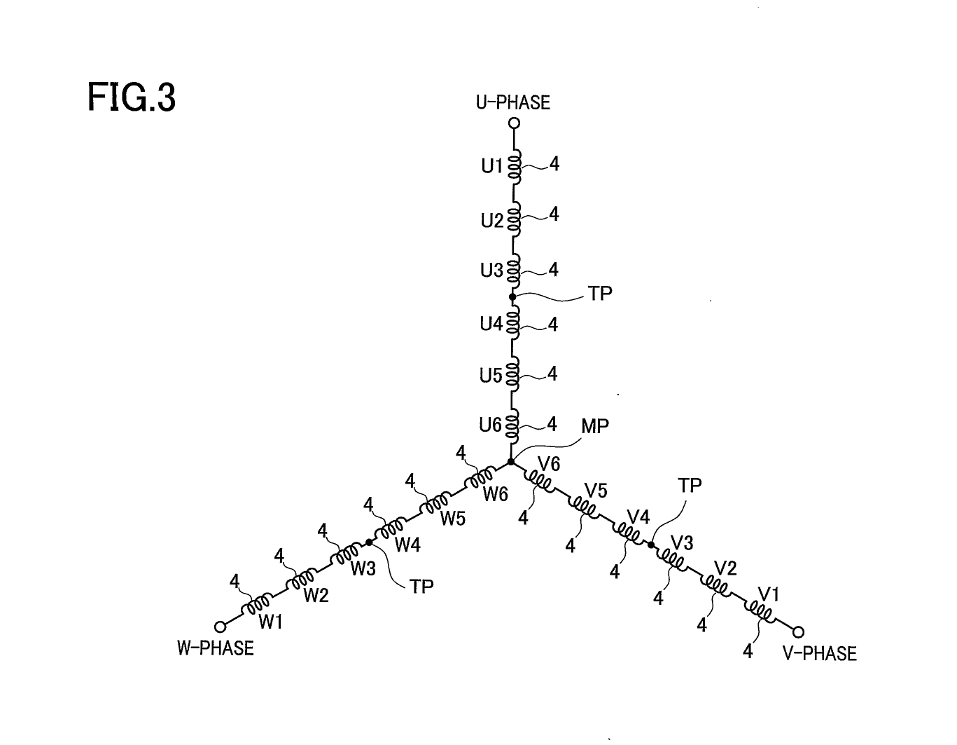

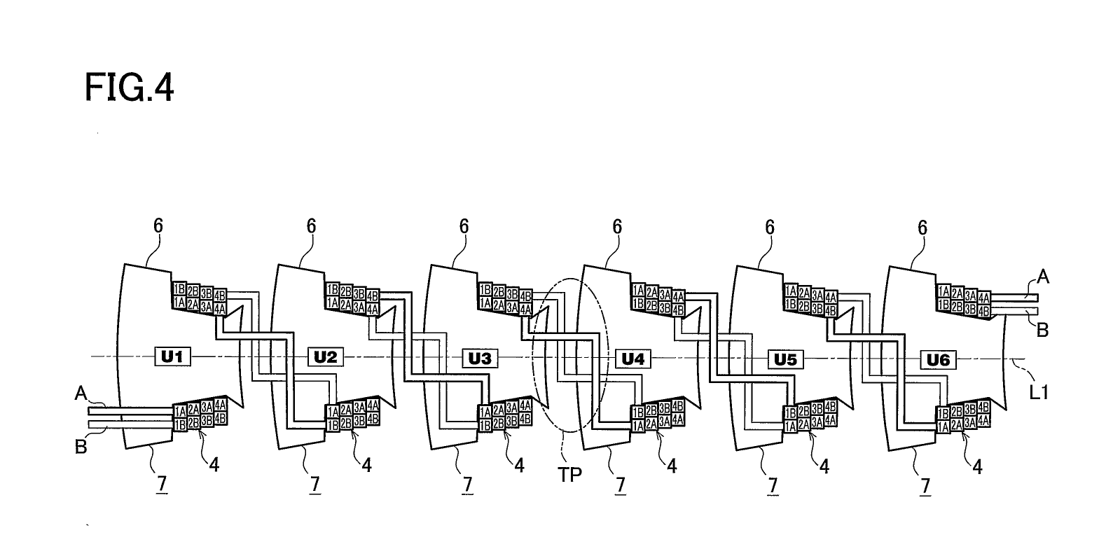

FIG. 3 is an electric circuit diagram showing an electric configuration of the stator 1 in this embodiment. The six windings 4 of the U1 to U6 constituting the U phase, the six windings 4 of the V1 to V6 constituting the V phase, and the six windings 4 of the W1 to W6 constituting the W phase are respectively connected in series. In the three windings 4 of the U6, V6, and W6 located at one ends of the respective phases U to W, the ends of the conductive wires A and B of these windings 4 are respectively connected together at the neutral point MP. In this embodiment, for example, the parallel winding wires, namely, the two conductive wires A and B are twisted in a position away from the neutral point MP by the lengths of the three windings 4, that is, at a twist position TP between the winding 4 of the phase U4 and the winding 4 of the phase U3. Thus, as shown in enlarged views of two circles enclosed by broken lines in FIG. 1, the winding bodies 7 of the phases U3 and U4 differ in that the inside and outside positions of the two conductive wires A and B are interchanged. FIG. 4 is a front view showing a series of six winding bodies 7 per U phase. As can be seen from FIG. 4, the two conductive wires A and B which are the parallel winding wires are twisted between the winding body 7 of the U3 phase and the winding body 7 of the U4 phase. This shows that the inside and outside positions of the two conductive wires A and B differ from each other between the three winding bodies 7 of the phases U1 to U3 and the three winding bodies 7 of the phases U4 to U6. Similarly, also in the six winding bodies 7 of each of the phases V and W, the parallel winding wires (conductive wires A and B) are twisted in the same way as described above. The term “twist” as used herein means that the two conductive wires A and B are rotated in parallel by 180°, whereby the positions of the two conductive wires A and B are interchanged.

The reason why the two conductive wires A and B of a series of six winding bodies 7 of each phase are twisted as described above is to prevent abnormal loss of electric current between the parallel winding wires. As shown in FIGS. 3 and 4, in this embodiment, the twist position TP is positioned between the winding body 7 of the U4 and the winding body 7 of the U3. That is, the parallel winding wires (two conductive wires A and B) extending between the winding bodies 7 are twisted at spacing intervals of N winding bodies so as to satisfy the following expression (1):

T=3×S×P×N (1)

where “P” means the number of conductive wires supplied to each winding body 7, for example, “2” in this embodiment, “T” means the number of all slots of the stator 1 (the number of winding bodies), for example, “18” in this embodiment, “S” means the number of neutral points (the number of stars), for example, “1” in this embodiment, and “N” is a nondimensional and natural number.

According to the above expression (1), “18=3×1×2×N” is obtained, resulting in “N=3”. Thus, as shown in FIG. 4, the parallel winding wires (two conductive wires A and B) between the winding bodies 7 are twisted at spacing intervals of three winding bodies.

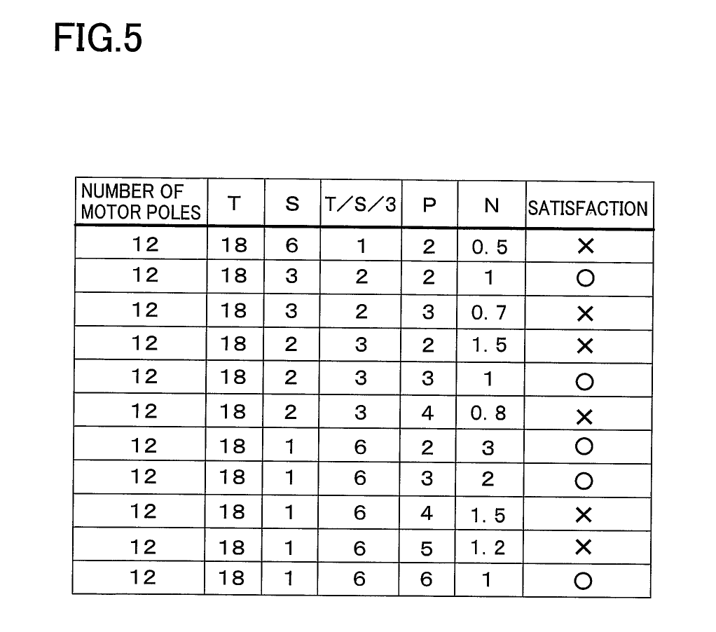

FIG. 5 is a listing showing combinations of numeric values “T, S, P, N” associated with the relationship indicated by the above expression (1). This table shows cases where the number of motor poles is specified as “12”, and the number of slots (the number of winding bodies) as “T=18”, like this embodiment. In this table, a case in which the above expression (1) is satisfied is indicated by a circle, and a case in which the above expression (1) is not satisfied is indicated by a cross. The combination of numeric values in the fifth line from the bottom of the table corresponds to the stator 1 of this embodiment. In another case, the table of FIG. 5 shows that when “T=18, S=3, and P=2”, the result of “N=1” is obtained, so that the parallel winding wires extending between the winding bodies are twisted at space intervals of one winding body. Similarly, when “T=18, S=2 and P=3”, the result of “N=1” is obtained, and thus the parallel winding wires extending between the winding bodies are twisted at space intervals of one winding body. Further, when “T=18, S=1, P=3”, the result of “N=2” is obtained, and thus the parallel winding wires extending between the winding bodies are twisted at space intervals of two winding bodies. When “T=18, S=1, P=6”, the result of “N=1” is obtained, and thus the parallel winding wires extending between the winding bodies are twisted at space intervals of one winding body.

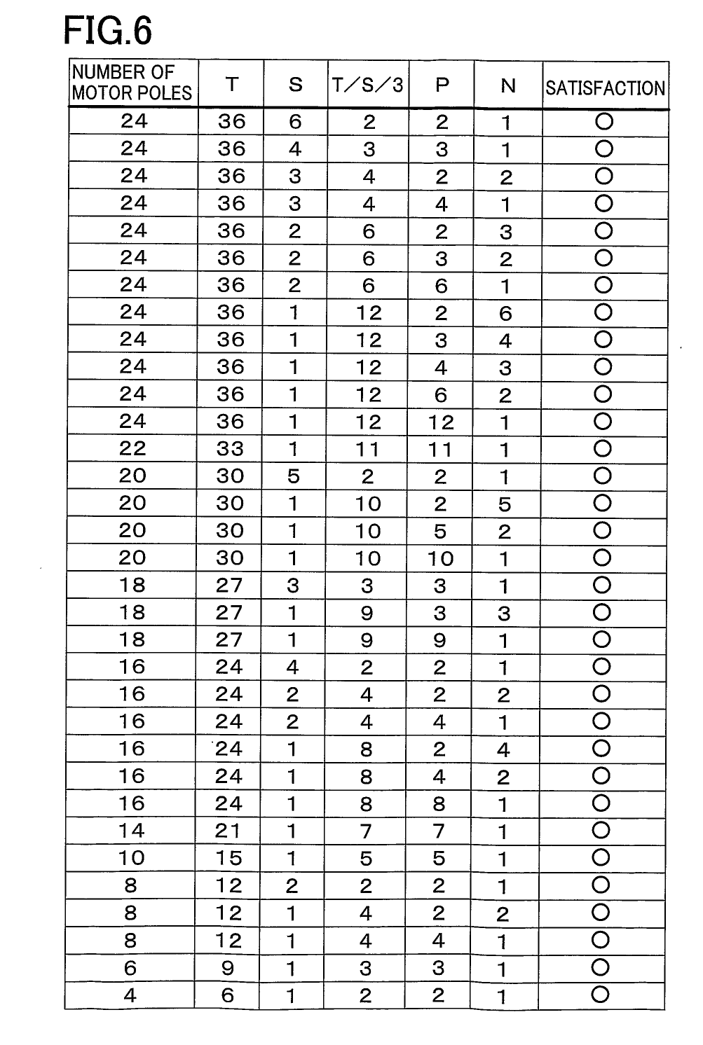

FIG. 6 is a listing showing combinations of numeric values “T, S, P, N” under conditions that satisfy the above expression (1) in other cases. FIG. 6 clearly shows that there are a number of cases that satisfy the relationship represented by the expression (1) under various conditions.

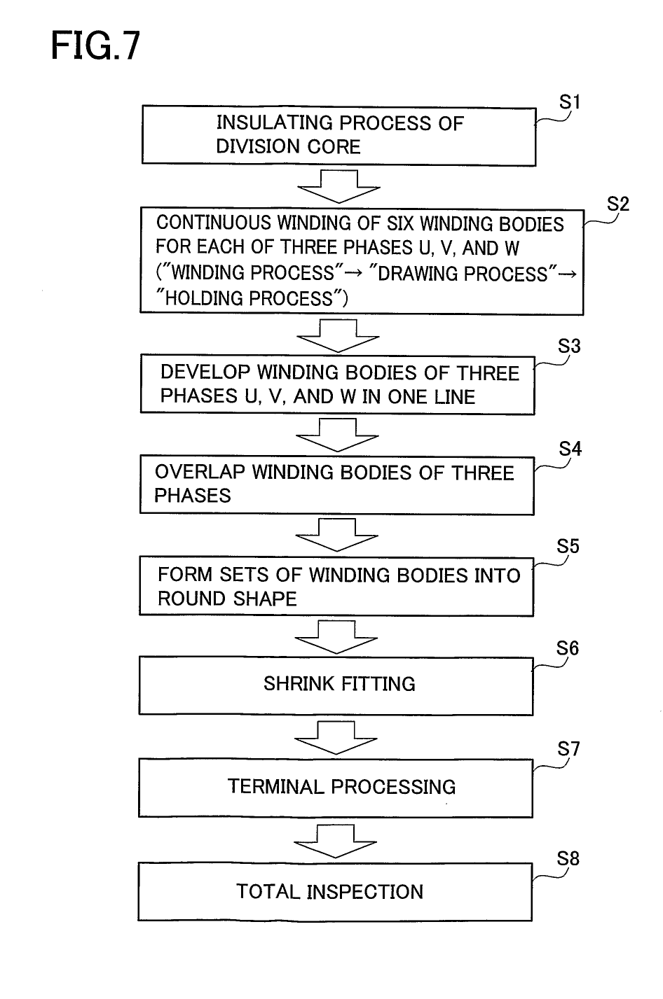

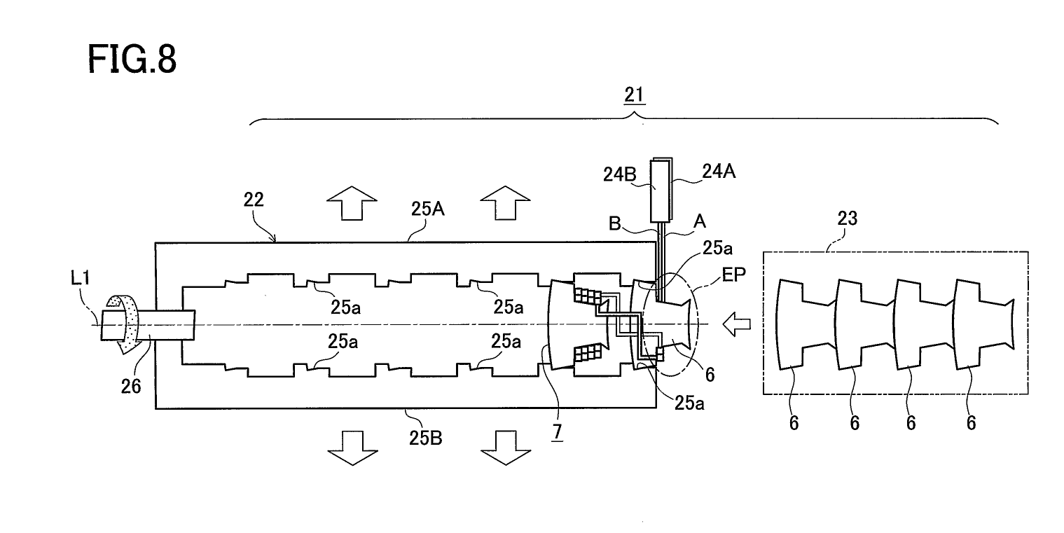

Now, a method of manufacturing a series of six winding bodies 7 for each phase will be described below with reference to FIG. 4. FIG. 7 shows a flowchart of the manufacturing method. FIGS. 8 to 13 are explanatory diagrams of steps in the method.

First, in step (hereinafter, “S”) 1, the surface of each division core 6 is subjected to an insulation process by using an insulating material.

Then, in S2, conductive wires are continuously wound to form six winding bodies 7 for each of three phases U, V, and W. This continuous winding process is performed using a continuous winding machine 21 shown in FIG. 8. FIG. 8 schematically shows the continuous winding machine 21. This machine 21 includes a holding device 22 for holding the winding body 7 and the division core 6, a core supply device 23 for supplying the division core 6 to the holding device 22, and a pair of conductive wire supply devices 24A and 24B for respectively supplying the two conductive wires A and B to the division cores 6 held by the holding device 22.

As shown in FIG. 8, the holding device 22 includes a pair of nipping frames 25A and 25B formed symmetrically with respect to an axis line L1 of the holding device, and a rotary shaft 26 disposed concentrically with respect to the axis line L1 at one ends of both nipping frames 25A and 25B. The nipping frames 25A and 25B have therein nipping forms 25a shaped to nip the six division cores 6 in total arranged in line at even intervals along the axis line L1. Both nipping frames 25A and 25B are allowed to open and close so as to hold and release the division cores 6. These nipping frames 25A and 25B can be rotated around the rotary shaft 26, while holding the division cores 6 and others. The core supply device 23 is configured to supply the division cores 6 one by one to the holding device 22, while holding the division cores 6 in line.

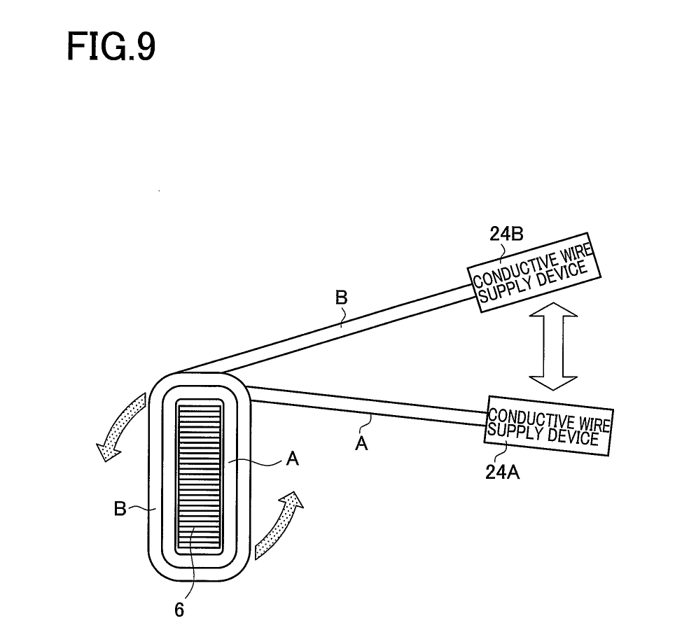

FIG. 9 is a schematic diagram of the conductive wire supply devices 24A and 24B. As shown in FIGS. 8 and 9, the conductive wire supply devices 24A and 24B are configured to supply the two conductive wires A and B respectively to each division core 6 which is rotated, while being held by one end of the holding device 22. As shown in FIG. 9, the conductive wire supply devices 24A and 24B are configured such that a conductive wire B or A to be laminated on the outer side is supplied before the conductive wire A or B on the inner side of the division core 6 is wound by one turn. Specifically, the conductive wire supply devices 24A and 24B disposed independently corresponding to the conductive wires A and B feed the respective conductive wires A and B before the division core 6 makes one turn by the holding device 22 (before the conductive wire A on the inner side is completely wound by one turn as shown in FIG. 9) such that the outer side conductive wire B is wound to be put on the conductive wire A. In contrast, in a case where the conductive wire B is wound on the inner side, the relative positions of the conductive wire supply devices 24A and 24B with respect to the rotary shaft and rotational direction of the division core 6 are changed upside down. In this embodiment, the two conductive wire supply devices 24A and 24B and the holding device 22 constitute the winding machine of the invention.

This step S2 includes a winding step, a drawing step, and a holding step. In the winding step, one division core 6 is held at an end position EP of the holding device 22 and the conductive wires A and B are wound around the division core 6 by use of the continuous winding machine 21. Thereafter, in the drawing step, after winding the conductive wires A and B around the division core 6, the conductive wires A and B are drawn by a crossover length for formation of the stator. As shown in FIG. 4, a length of the conductive wires A and B for connecting the adjacent winding bodies 7 corresponds to the crossover length. Then, in the holding step, after the conductive wires A and B are drawn by the crossover length, both the nipping frames 25A and 25B of the holding device 22 are opened once, causing the division core 6 to move in the direction of the rotary shaft 26. The nipping frames 25A and 25B are then closed again, thereby holding the division core 6 again by the holding device 22, while holding a next division core 6 at the end position EP of the holding device 22. In this way, a series of processes, including the winding step, the drawing step, and the holding step, is repeatedly carried out in S2, so that the conductive wires A and B are wound around the six division cores 6 constituting the winding bodies 7 belonging to the same one of the phases U, V, W.

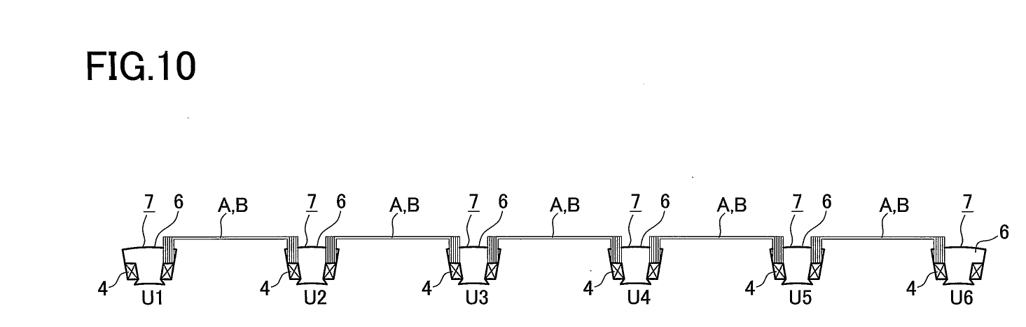

In S3, successively, a series of winding bodies 7 are developed in line for each of the three phases U, V, and W as shown in FIG. 10. FIG. 10 shows a series of winding bodies 7 of the U phase, for example.

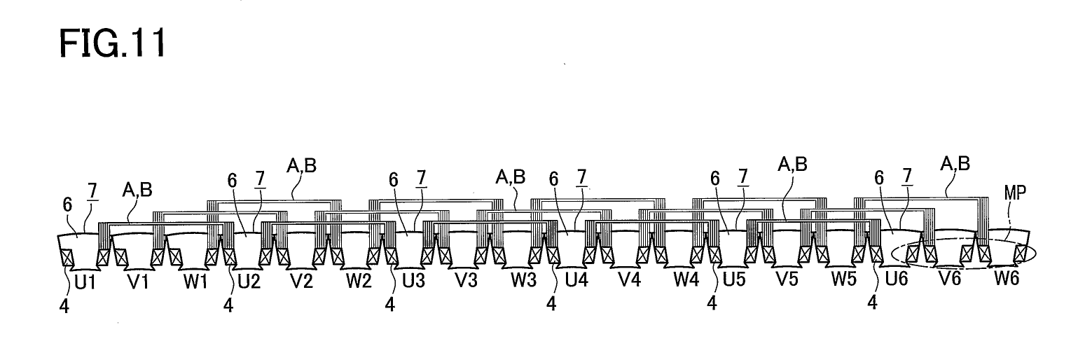

Thereafter, in S4, as shown in FIG. 11, the respective series of the winding bodies 7 of the three phases U, V, and W are arranged so that the winding bodies 7 of different phases are adjacently disposed and displaced by one phase from one another. In FIG. 11, the right end corresponds to a neutral point MP.

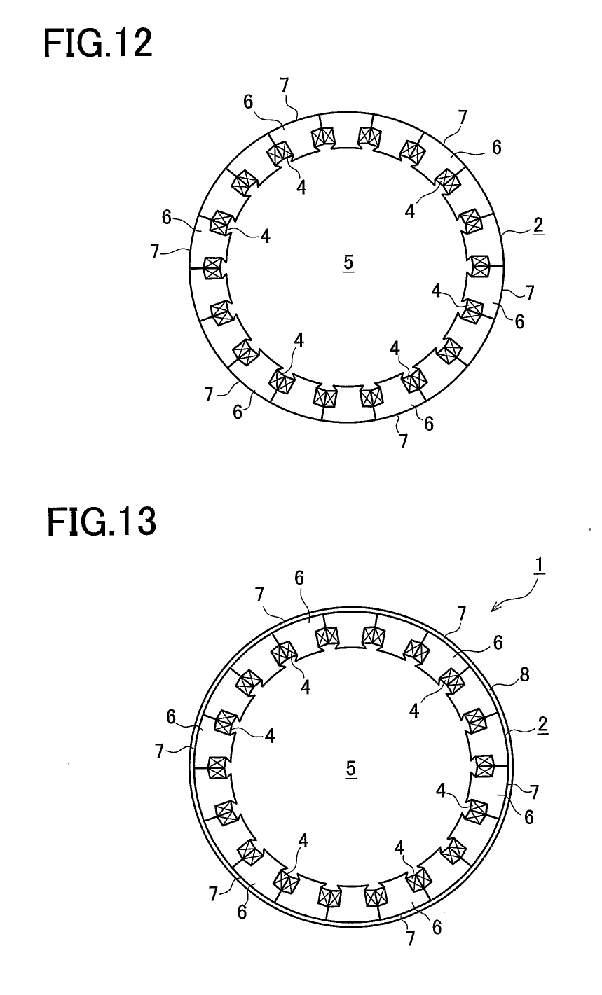

In S5, three sets of the winding bodies 7 of the three phases which are arranged as above so that the winding bodies 7 of different phases are displaced by one phase from one another are shaped into a round configuration to produce the stator core 2, as shown in FIG. 12.

Then, in S6, the division fixing ring 8 is attached on the outer periphery of the round-shaped stator core 2, so that the winding bodies 7 are fixed and thus positioned to form an integral annular configuration. These elements are subjected to shrink fitting, which completes the manufacturing of the basic structure of the stator 1.

Thereafter, in S7, terminals of the stator 1 subjected to the shrink fitting are processed. In S8, a total inspection is performed as part of quality management of products. In this way, the manufacturing of the stator 1 is completed.

According to the stator structure of the rotary electric machine and the manufacturing method thereof in this embodiment, the following advantages are obtained. In the winding body 7 of the concentrated winding type in which two conductive wires A and B are wound in rows, these two wires A and B are wound around one slot 3 in each phase. However, an adverse influence may occur due to unbalance of leakage magnetic flux induced in each of the conductive wires A and B in the slot 3, or a difference in inductance due to a difference in circumferential length between the conductive wires A and B with the same turn. This may result in loss of circulating electric current or the like. In order to cope with this problem, according to the structure of the stator 1 of this embodiment, the parallel winding wires (two conductive wires A and B) extending between the winding bodies 7 are twisted at spacing intervals of N winding bodies under the condition satisfying the above-mentioned expression (1). The difference in inductance due to the difference in leakage magnetic flux between the conductive wires A and B, which may be caused in one winding body 7, is offset between the winding bodies 7 before and after the twist position where the parallel winding wires (two conductive wires A and B) are twisted in the same phase. In this embodiment, for example, the difference in inductance occurring at the winding body 7 of the U3 is offset at the winding body 7 of the next U4. Thus, the stator 1 of the rotary electric machine can reduce the loss of circulating electric current or the like.

The two conductive wires A and B need not be twisted and interchanged inside the corresponding winding 4 of one winding body 7. This can reduce the winding disorder of the winding 4 without rendering winding ends (coil ends) bulky, thus making the winding 4 compact.

In this embodiment, the two conductive wires A and B are wound as the parallel winding wires with the same turn on the inner and outer sides. Therefore, these two conductive wires A and B are brought into contact together with the same turns. Thus, a voltage needed between the turns is about a withstand voltage per turn. This is a film withstand voltage which is equal to or less than half that in the prior art. This can decrease a difference in potential between the turns. Further, the two conductive wires A and B are independently wound as the parallel winding wires, which reduce a load applied to the division core 6 when the conductive wires A and B are wound around the division core 6. Specifically, in the parallel winding wires of this embodiment, the load applied to the division core 6 is decreased to about one fourth of that in a rectangular conductive wire constituted of two conductive wires formed integrally. The stiffness of the division core 6 can be reduced by a degree corresponding to the decrease in the load applied, and hence the division core 6 can be manufactured at low cost.

In this embodiment, one division core 6 is supplied from the core supply device 23 and held by the holding device 22 of the continuous winding machine 21, and then the two conductive wires A and B are wound around the division core 6 held by the holding device 22. After winding the two conductive wires A and B, the conductive wires A and B each are drawn by the crossover length. The division core 6 with the two conductive wires A and B wound therearound is moved along the axis line L1 inside the holding device 22, and then held by the holding device 22 together with a next division core 6. Then, the conductive wires A and B are newly wound around the next division core 6. In this way, the series of processes is continuously repeated. The series of six winding bodies 7 constituting each phase are formed continuously, which eliminates the necessity of individually connecting the parallel windings wires (two conductive wires A and B) between the winding bodies 7. This can simplify the manufacturing process of the stator 1.

In this embodiment, the two conductive wire supply devices 24A and 24B are provided for supplying the two conductive wires A and B respectively. The supply devices are configured in such a manner that before the conductive wire A or B is wound on the inner side by one turn, the conductive wire B or A to be put on the outside of the inner side wire is supplied. Thus, when the outer side conductive wire B or A is wound on the inner side conductive wire A or B, not only the tension of the outer side conductive wire B or A, but also that of the inner side conductive wire A or B can be adjusted. The inner side conductive wire A or B and the outer side conductive wire B or A are not wound individually, which can lessen the number of winding operations. This can reduce damage to the conductive wires A and B due to the winding operation, resulting in a reduction in time required for winding the wires A and B.

According to the manufacturing method of this embodiment, the division core 6 is constructed of the divided stator core 2. The series of six winding bodies 7 for each of the phases U, V, W are formed continuously using these division cores 6. The continuous winding bodies 7 of the adjacent three phases U, V, and W are arranged so that the winding bodies 7 of different phases are displaced by one phase from one another. These winding bodies are then positioned in an annular shape to be integrally formed as the annular stator 1. Accordingly, each winding body 7 does not need to be individually fixed to the core body, and the parallel windings wires (conductive wires A and B) are not required to be connected every between the winding bodies 7. Thus, each winding body 7 is not fixed to the core body, and the winding wires do not need to be connected individually between the winding bodies 7, which simplifies the manufacturing process of the stator 1.

### Second Embodiment

Next, a second embodiment of the invention which embodies a stator structure of the rotary electric machine will be described below in detail with reference to the accompanying drawings.

In each embodiment to be described later (including the second embodiment), the same components as those of the first embodiment are designated by the same reference numerals, and thus a description thereof will be omitted below. Different points from the first embodiment will be mainly explained below.

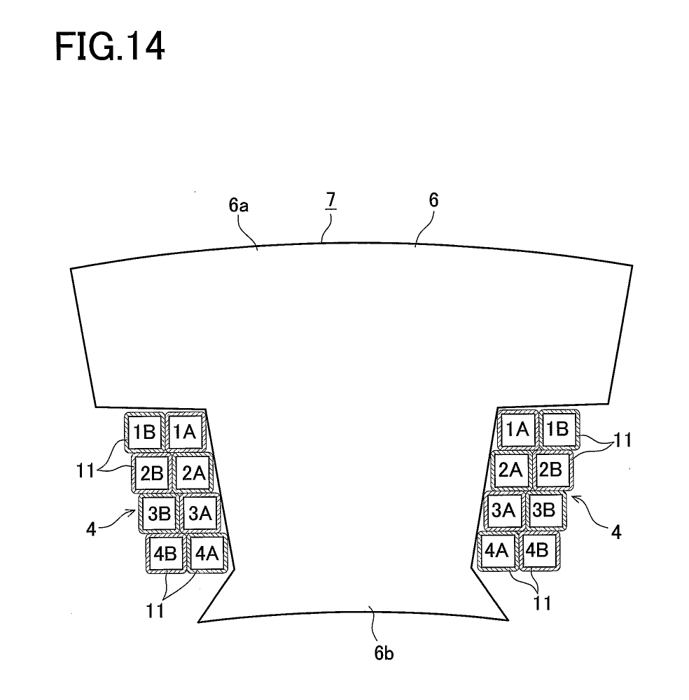

FIG. 14 is a front view showing a winding body 7 based on FIG. 2. As shown in FIG. 14, this embodiment differs from the first embodiment in that two conductive wires A and B are coated with insulating films 11 made of the same material. Since the two conductive wires A and B are coated with such insulating films 11, these two conductive wires A and B are bonded together with the insulating film 11, so that the wires A and B can be easily handled as a bundle. This can prevent the winding disorder of a winding 4. Other operations and advantages are the same as those of the first embodiment.

### Third Embodiment

Next, a third embodiment of the invention which embodies a stator structure of the rotary electric machine will be described below in detail with reference to the accompanying drawings.

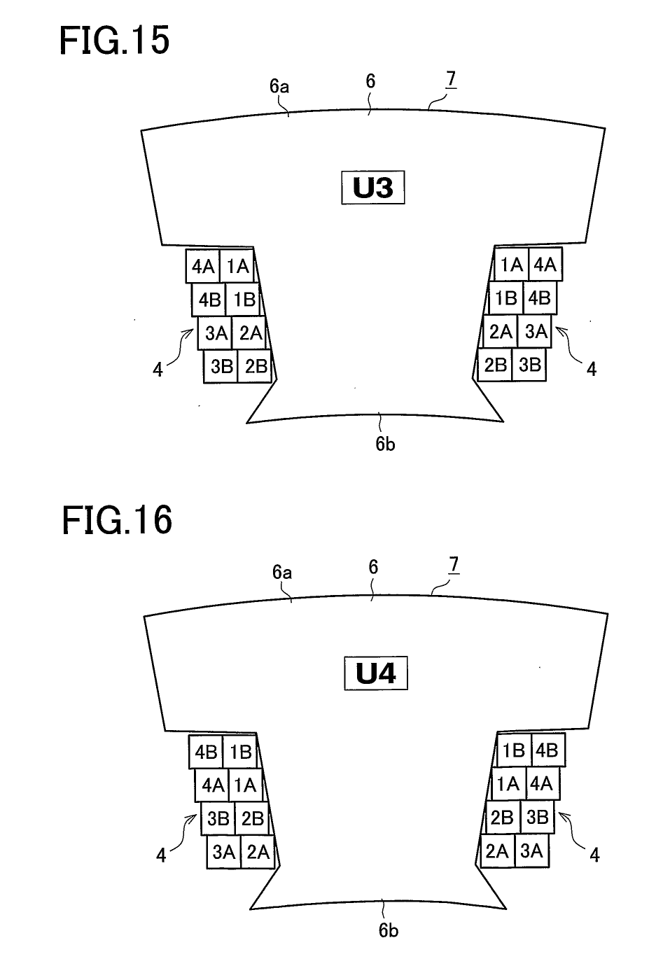

This embodiment differs from each of the above-mentioned embodiments in how to wind the two conductive wires A and B as the parallel winding wires around the division core 6. FIGS. 15 and 16 are front views showing a winding body 7 constituting the U phase, corresponding to FIG. 2. FIG. 15 shows the winding body 7 of the U3, and FIG. 16 shows the winding body of the U4. These winding bodies 7 of the U3 and U4 are contained in a series of six winding bodies 7 corresponding to FIG. 4.

The two conductive wires A and B form the parallel winding wires wound in rows. These parallel winding wires are integrally wound around the division core 6 from the inner side in turn, and the parallel winding wires on the outer side (two conductive wires A and B) are wound, overlapping the parallel winding wires (two conductive wires A and B) wound on the inner side. Specifically, as shown in FIG. 15, two parallel winding wires (conductive wires 1A and 1B) for the first turn are integrally wound on the division core 6 on the inner side. Then, the two parallel winding wires (conductive wires 2A and 2B) for the second turn are integrally wound on the inner side. Next, the parallel winding wires (conductive wires 3A and 3B) for the third turn on the outer side are wound to overlap the parallel winding wires (conductive wires 2A and 2B) wound on the inner side at the second turn. Finally, the parallel winding wires (conductive wires 4A and 4B) for the fourth turn on the outer side are wound to overlap the parallel winding wires (conductive wires 1A and 1B) wound on the inner side at the first turn. In this way, the winding body 7 of the U3 is manufactured.

After manufacturing the winding body 7 of the U3, the subsequent parallel winding wires formed of the two conductive wires A and B are partly twisted, and then wound around another division core 6 in the same way as described above. That is, as shown in FIG. 16, the two parallel winding wires (conductive wires 1B and 1A) for the first turn are integrally wound on the division core 6 on the inner side. Then, the two parallel winding wires (conductive wires 2B and 2A) for the second turn are integrally wound on the inner side. Next, the parallel winding wires (conductive wires 3B and 3A) for the third turn on the outer side are wound to overlap the parallel winding wires (conductive wires 2B and 2A) wound on the inner side at the second turn. Thereafter, the parallel winding wires (conductive wires 4B and 4A) for the fourth turn on the outer side are wound to overlap the parallel winding wires (conductive wires 1B and 1A) wound on the inner side at the first turn. In this way, the winding body 7 of the U4 is manufactured.

In this embodiment, the parallel winding wires formed of the two conductive wires A and B are wound from the inner side in turn and the outer side parallel winding wires are wound to overlap the inner side parallel winding wires. Therefore, in the winding 4, the wires can be united in individual layers. This makes it possible to prevent the winding disorder of the winding 4.

### Fourth Embodiment

Now, a fourth embodiment of the invention which embodies a stator structure of the rotary electric machine will be described below in detail with reference to the accompanying drawings.

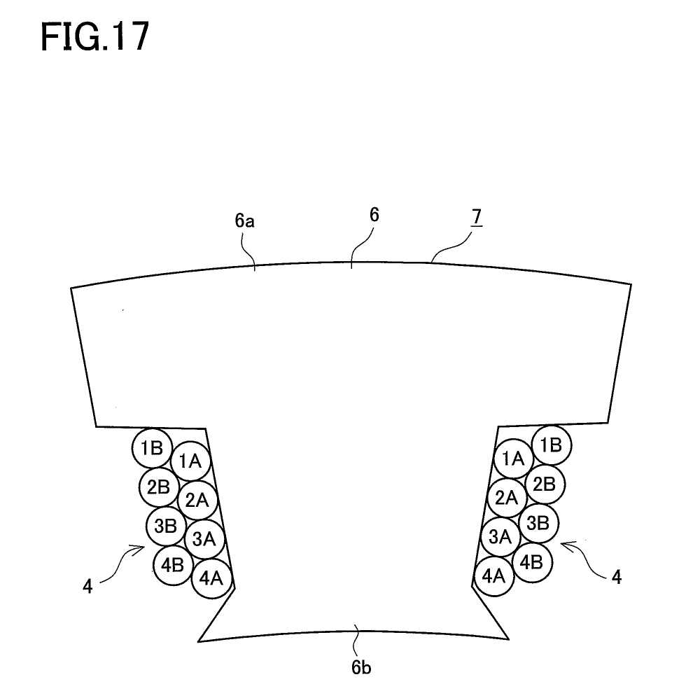

This embodiment differs from the first embodiment in structure, including the shapes of two conductive wires A and B constituting the parallel winding wires, and how to wind these wires around the division core 6. FIG. 17 is a front view showing a winding body 7 corresponding to FIG. 2.

In this embodiment, each of two conductive wires A and B constituting the parallel winding wires has a circular cross section rather than a rectangular cross section. The conductive wire B wound on the outer side is shifted to be disposed between the rows of the conductive wire A wound on the inner side. In this embodiment, the winding position of the conductive wire B is shifted in the direction of a minus one turn with respect to the conductive wire A wound on the inner side, and then the conductive wire B is wound.

Thus, a generally used wire of a circular cross section can be used as the conductive wires A and B in this embodiment, the stator 1 can be manufactured at relatively low cost.

### Fifth Embodiment

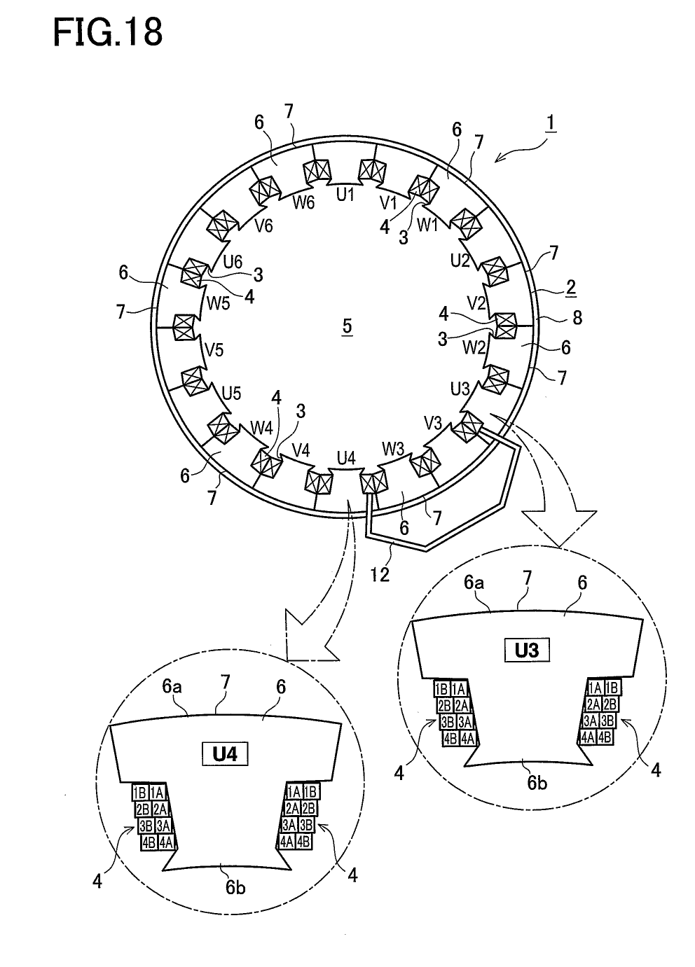

Now, a fifth embodiment of the invention which embodies a stator structure of the rotary electric machine will be described below in detail with reference to FIG. 18.

This embodiment differs from the first embodiment in that the parallel winding wires between the winding body 7 of the U3 and the winding body 7 of U4 are coupled to each other through a bus bar 12 with a twist portion. In other words, in this embodiment, the windings 4 of the adjacent winding bodies 7 are coupled to each other through the bus bar 12 with the twist portion in a position where the two conductive wires A and B which are the parallel winding wires are to be twisted for a series of six winding bodies 7 of each phase constituting the stator 1. In the bus bar 12 with the twist portion for the two conductive wires, the positions of the two connection terminals are interchanged between one end and the other end of the bus bar 12. Thus, the connection of the two conductive wires A and B using the bus bar 12 provides the same condition as that in which the two conductive wires A and B are twisted, without actually twisting the two conductive wires A and B between the adjacent winding bodies 7.

In this embodiment, consequently, the adjacent winding bodies 7 between which the twist should be made are coupled to each other through the bus bar 12 with the twist portion, the conductive wires A and B between the winding bodies 7 do not need to be twisted, and hence equipment for twisting is not required. This can simplify the winding machine for sequentially winding the conductive wires A and B around each of six division cores 6.

The present invention may be embodied in other specific forms without departing from the essential characteristics thereof.

For instance, the parallel winding wires in the aforementioned embodiments are formed of the two conductive wires A and B. They may alternatively be constituted of three or more conductive wires.

The combination of numeric values for the number of all slots (T) of the stator, the number of neutral points (S), the number of conductive wires (P), and the nondimensional number (N) can be determined appropriately to any combination that satisfies the relation (1) as shown in FIGS. 5 and 6.

1. A stator structure of rotary electric machine, including a plurality of winding bodies of a concentrated winding type, each having a plurality of conductive wires wound in rows,
wherein when it is assumed that the number of conductive wires supplied to each of the winding bodies is P, the number of slots (winding bodies) of the entire stator is T, and the number of neutral points (the number of stars) is S, winding wires extending between the winding bodies are twisted at spacing intervals of N winding bodies (N is a natural number) determined to satisfy a relation:
T=3×S×P×N.

2. The stator structure of rotary electric machine according to claim 1, wherein the plurality of conductive wires are two wires of a first conductive wire and a second conductive wire, which are wound in rows as parallel winding wires so that the first conductive wire is wound on an inner side and the second conductive wire is wound on an outer side to overlap the first conductive wire, the first and second conductive wires being wound with the same turns on the inner and outer sides.

3. The stator structure of rotary electric machine according to claim 1, wherein the winding wires between the winding bodies are coupled to each other through a bus bar with a twisted portion.

4. The stator structure of rotary electric machine according to claim 2, wherein the conductive wire has a circular cross section, and the conductive wire wound on the outer side is disposed between the rows of the conductive wire wound on the inner side.

5. The stator structure of rotary electric machine according to claim 2, wherein the two conductive wires are coated with insulating films made of the same materials.

6. The stator structure of rotary electric machine according to claim 1, wherein the plurality of conductive wires are two wires of a first conductive wire and a second conductive wire, which are wound in rows as parallel winding wires so that the parallel winding wires are wound sequentially from an inner side and the parallel winding wires on an outer side are wound to overlap the parallel winding wires wound on the inner side.

7. A winding machine for the stator structure of rotary electric machine according to claim 1, wherein
the winding machine includes a conductive wire supply device for individually supplying the conductive wires in such a manner as to supply the conductive wire to be put on the outer side before the conductive wire to be put on the inner side is completely wound by one turn.

8. A method of manufacturing the stator structure of rotary electric machine according to claim 1,
wherein the method uses a holding device that holds a plurality of bobbins constituting the winding bodies for the same phase, on the same rotational axis, and
the method comprises a series of processes including:
winding the conductive wires around one bobbin held at an end position of the holding device;
drawing the conductive wires by a crossover length for formation of the stator after the winding of the winding wires around the bobbin; and
moving the bobbin along the rotational axis to a predetermined position after the drawing of the conductive wires by the crossover length, and holding another bobbin in the end position of the holding device,
the series of processes is repeated to wind the conductive wires around the plurality of bobbins constituting the winding bodies for the same phase.

9. A method of manufacturing a stator, including:
forming a bobbin from a stator core divided into pieces; and
arranging a plurality of sets of the winding bodies for different phases manufactured according to the manufacturing method set forth in claim 8 so that the winding bodies of different phases are disposed adjacently and displaced by one phase from one another, and
positioning the winding bodies to form an integral annular configuration.

10. A winding machine for the stator structure of rotary electric machine according to claim 2, wherein
the winding machine includes a conductive wire supply device for individually supplying the conductive wires in such a manner as to supply the conductive wire to be put on the outer side before the conductive wire to be put on the inner side is completely wound by one turn.

11. A winding machine for the stator structure of rotary electric machine according to claim 3, wherein
the winding machine includes a conductive wire supply device for individually supplying the conductive wires in such a manner as to supply the conductive wire to be put on the outer side before the conductive wire to be put on the inner side is completely wound by one turn.

12. A winding machine for the stator structure of rotary electric machine according to claim 4, wherein
the winding machine includes a conductive wire supply device for individually supplying the conductive wires in such a manner as to supply the conductive wire to be put on the outer side before the conductive wire to be put on the inner side is completely wound by one turn.

13. A method of manufacturing the stator structure of rotary electric machine according to claim 2,
wherein the method uses a holding device that holds a plurality of bobbins constituting the winding bodies for the same phase, on the same rotational axis, and
the method comprises a series of processes including:
winding the conductive wires around one bobbin held at an end position of the holding device;
drawing the conductive wires by a crossover length for formation of the stator after the winding of the winding wires around the bobbin; and
moving the bobbin along the rotational axis to a predetermined position after the drawing of the conductive wires by the crossover length, and holding another bobbin in the end position of the holding device,
the series of processes is repeated to wind the conductive wires around the plurality of bobbins constituting the winding bodies for the same phase.

14. A method of manufacturing the stator structure of rotary electric machine according to claim 4,
wherein the method uses a holding device that holds a plurality of bobbins constituting the winding bodies for the same phase, on the same rotational axis, and
the method comprises a series of processes including:
winding the conductive wires around one bobbin held at an end position of the holding device;
drawing the conductive wires by a crossover length for formation of the stator after the winding of the winding wires around the bobbin; and
moving the bobbin along the rotational axis to a predetermined position after the drawing of the conductive wires by the crossover length, and holding another bobbin in the end position of the holding device,
the series of processes is repeated to wind the conductive wires around the plurality of bobbins constituting the winding bodies for the same phase.

15. A method of manufacturing the stator structure of rotary electric machine according to claim 5,
wherein the method uses a holding device that holds a plurality of bobbins constituting the winding bodies for the same phase, on the same rotational axis, and
the method comprises a series of processes including:
winding the conductive wires around one bobbin held at an end position of the holding device;
drawing the conductive wires by a crossover length for formation of the stator after the winding of the winding wires around the bobbin; and
moving the bobbin along the rotational axis to a predetermined position after the drawing of the conductive wires by the crossover length, and holding another bobbin in the end position of the holding device,
the series of processes is repeated to wind the conductive wires around the plurality of bobbins constituting the winding bodies for the same phase.

16. A method of manufacturing the stator structure of rotary electric machine according to claim 6,
wherein the method uses a holding device that holds a plurality of bobbins constituting the winding bodies for the same phase, on the same rotational axis, and
the method comprises a series of processes including:
winding the conductive wires around one bobbin held at an end position of the holding device;
drawing the conductive wires by a crossover length for formation of the stator after the winding of the winding wires around the bobbin; and
moving the bobbin along the rotational axis to a predetermined position after the drawing of the conductive wires by the crossover length, and holding another bobbin in the end position of the holding device,
the series of processes is repeated to wind the conductive wires around the plurality of bobbins constituting the winding bodies for the same phase.

17. A method of manufacturing a stator, including:
forming a bobbin from a stator core divided into pieces; and
arranging a plurality of sets of the winding bodies for different phases manufactured according to the manufacturing method set forth in claim 13 so that the winding bodies of different phases are disposed adjacently and displaced by one phase from one another, and
positioning the winding bodies to form an integral annular configuration.

18. A method of manufacturing a stator, including:
forming a bobbin from a stator core divided into pieces; and
arranging a plurality of sets of the winding bodies for different phases manufactured according to the manufacturing method set forth in claim 14 so that the winding bodies of different phases are disposed adjacently and displaced by one phase from one another, and
positioning the winding bodies to form an integral annular configuration.

19. A method of manufacturing a stator, including:
forming a bobbin from a stator core divided into pieces; and
arranging a plurality of sets of the winding bodies for different phases manufactured according to the manufacturing method set forth in claim 15 so that the winding bodies of different phases are disposed adjacently and displaced by one phase from one another, and
positioning the winding bodies to form an integral annular configuration.

20. A method of manufacturing a stator, including:
forming a bobbin from a stator core divided into pieces; and
arranging a plurality of sets of the winding bodies for different phases manufactured according to the manufacturing method set forth in claim 16 so that the winding bodies of different phases are disposed adjacently and displaced by one phase from one another, and
positioning the winding bodies to form an integral annular configuration.
